(19) United States
(12) Patent Application Publication
(10) Pub. No.: US 2007/0157727 A1
(43) Pub. Date: Jul. 12, 2007

(54) Image resolution enhancing apparatus and method

(75) Inventors: Jong-hwa Won, Seoul (KR); Sung-hoon Choa, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/599,486

(22) Filed: Nov. 15, 2006

(30) Foreign Application Priority Data
Jan. 7, 2006 (KR) 10-2006-0002035

(51) Int. Cl. G01P 15/00

(52) U.S. Cl. 73/488

(57) ABSTRACT

An image resolution enhancing apparatus and method are provided. The image resolution enhancing apparatus includes: a scanner, a synchronous detector, a wave generator, a high voltage amplifier, a resonant frequency detector, a multiplier which multiplies the resonant frequency of the scanner which is detected by the resonant frequency detector by the horizontal resolution of a display screen; a frequency oscillator which oscillates at a pixel frequency which corresponds to the multiplication result of the multiplier; and a pulse generator which generates a pulse which corresponds to the pixel frequency oscillations of the frequency oscillator and outputs the generated pulse to the wave generator, wherein the wave generator adds the pulse generated by the pulse generator to the wave to generate a composite wave.

### CROSS-REFERENCE TO RELATED PATENT APPLICATION

This application claims priority from Korean Patent Application No. 10-2006-0002035, filed on Jan. 7, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to resonant driving of an electrostatic capacity micro mirror of a scanner, and more particularly, to an image resolution enhancer and an image resolution enhancing method which enhances a horizontal resolution.

2. Description of the Related Art

To electrostatically drive a micro-mirror, an apparatus for horizontally driving includes a horizontal synchronous detector, a triangle, square or sine wave generator, and a high voltage amplifier which amplifies the generated wave. An apparatus for vertically driving includes a vertical synchronous detector, a sawtooth wave generator, and a high voltage amplifier which amplifies the generated wave.

When electrostatically driving a micro-mirror, a horizontal driving voltage such as a triangle, square, or sine wave is applied to the micro-mirror, and a vertical driving voltage such as a step wave is applied to the micro-mirror according to the horizontal synchronization signal.

In the case of a horizontal operation, it is desirable that the micro-mirror be intermittently driven. However, the horizontal operation is designed to cause resonance, so an angle is continuously increased or decreased. Therefore, a spot does not remain in one pixel, and image information or different pixels overlap. Accordingly, the resolution of an image is reduced.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image resolution enhancing apparatus and method capable of improving horizontal resolution by driving a micro-mirror of a scanner in consideration of a pixel frequency.

According to an aspect of the present invention, there is provided an image resolution enhancing apparatus which has a scanner, a synchronous detector, a wave generator, a high voltage amplifier, and a resonant frequency detector. The image resolution enhancer includes a resonant frequency detector which detects a resonant frequency of the scanner; a multiplier which multiplies the detected resonant frequency by the horizontal resolution of a display screen; a frequency oscillator which oscillates at a pixel frequency which corresponds to the multiplication result of the multiplier; and a pulse generator which generates a pulse which corresponds to the pixel frequency oscillations of the frequency oscillator and provides the generated pulse to the wave generator, wherein the wave generator adds the pulse received from the pulse generator to the wave to generate a composite waveform.

According to another aspect of the present invention, there is provided an image resolution enhancing apparatus which has a scanner, a synchronous detector, a wave generator, a high voltage amplifier, and a resonant frequency detector, the image resolution enhancer includes a resonant frequency detector which detects a resonant frequency of the scanner; a multiplier which multiplies the detected resonant frequency by the horizontal resolution of a display screen; a frequency oscillator which oscillates at a pixel frequency which corresponds to the multiplication result of the multiplier; and a pulse generator which generates a pulse which corresponds to the pixel frequency oscillations of the frequency oscillator; and a synthesizer which adds the pulse which is generated by the pulse generator to the wave which is generated by the wave generator and amplified by the high voltage amplifier and outputs the composite waveform to the scanner.

According to another aspect of the present invention, there is provided an image resolution enhancing apparatus which has a scanner, a synchronous detector, a wave generator, a high voltage amplifier, and a resonant frequency detector, the image resolution enhancer including: a resonant frequency detector which detects a resonant frequency of the scanner; a multiplier which multiplies the detected resonant frequency by the horizontal resolution of a display screen; a frequency oscillator which oscillates at a pixel frequency which corresponds to the multiplication result of the multiplier; and a pulse generator which generates a pulse which corresponds to the pixel frequency oscillations of the frequency oscillator; and a synthesizer which adds the pulse generated by the pulse generator to the wave generated by the wave generator and outputs the composite waveform to the high voltage amplifier.

According to another aspect of the present invention, there is provided an image resolution enhancing method of an image resolution enhancing apparatus which has a scanner, a synchronous detector, a wave generator, a high voltage amplifier, and a resonant frequency detector, the method including: detecting the resonant frequency of the scanner with a resonant frequency detector; multiplying the resonant frequency of the scanner detected by the resonant frequency detector by the horizontal resolution of a display screen; oscillating at a pixel frequency corresponding to the multiplication result; generating a pulse corresponding to the pixel frequency oscillations and providing the pulse to the wave generator; generating a wave in the waveform generator by adding the generated pulse to a wave; amplifying the generated waveform in the high voltage amplifier,; and scanning an image in the scanner according to the amplified waveform.

According to another aspect of the present invention, there is provided an image resolution enhancing method of an image resolution enhancing apparatus which has a scanner, a synchronous detector, a wave generator, a high voltage amplifier, and a resonant frequency detector, the method including: detecting the resonant frequency of the scanner with a resonant frequency detector; multiplying the resonant frequency of the scanner detected by the resonant frequency detector by the horizontal resolution of a display screen; oscillating at a pixel frequency corresponding to the multiplication result; generating a pulse corresponding to the pixel frequency oscillations; adding the generated pulse to a wave which is generated by the wave generator and amplified by the high voltage amplifier to obtain a composite waveform and providing the composite waveform to the scanner; and scanning an image in the scanner according to the amplified wave.

According to another aspect of the present invention, there is provided an image resolution enhancing method of an image resolution enhancing apparatus having a scanner, a synchronous detector, a wave generator, a high voltage amplifier, and a resonant frequency detector, the method including: detecting the resonant frequency of the scanner with a resonant frequency detector; multiplying the resonant frequency of the scanner detected by the resonant frequency detector by the horizontal resolution of a display screen; oscillating at a pixel frequency corresponding to the multiplication result; generating a pulse corresponding to the pixel frequency oscillations; adding the generated pulse to a wave which is generated by the wave generator to obtain a composite waveform and outputting the composite waveform to the high voltage amplifier; amplifying the composite waveform in the high voltage amplifier; and scanning an image in the scanner according to the amplified wave.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an image resolution enhancer according to an exemplary embodiment of the present invention;

FIG. 2 shows a pulse generated by a pulse generator according to an exemplary embodiment of the present invention;

FIGS. 3A through 3C show various composite waveforms generated by adding a pulse to triangle, square, and sine waves according to exemplary embodiments of the present invention and explain the improvement of an image resolution;

FIG. 4 is a block diagram of an image resolution enhancer according to another exemplary embodiment of the present invention;

FIG. 5 is a block diagram of an image resolution enhancer according to another exemplary embodiment of the present invention;

FIG. 6 is a flowchart of an image resolution enhancing method according to an exemplary embodiment of the present invention;

FIG. 7 is a flowchart of an image resolution enhancing method according to another exemplary embodiment of the present invention; and

FIG. 8 is a flowchart of an image resolution enhancing method according to another exemplary embodiment of the present invention.

### DETAILED DESCRIPTION OF EXEMPLARY EMBODIMENTS OF THE INVENTION

Hereinafter, an image resolution enhancing apparatus according to the exemplary embodiments of the present invention will be described in detail with reference to the accompanying drawings in which exemplary embodiments of the invention are illustrated.

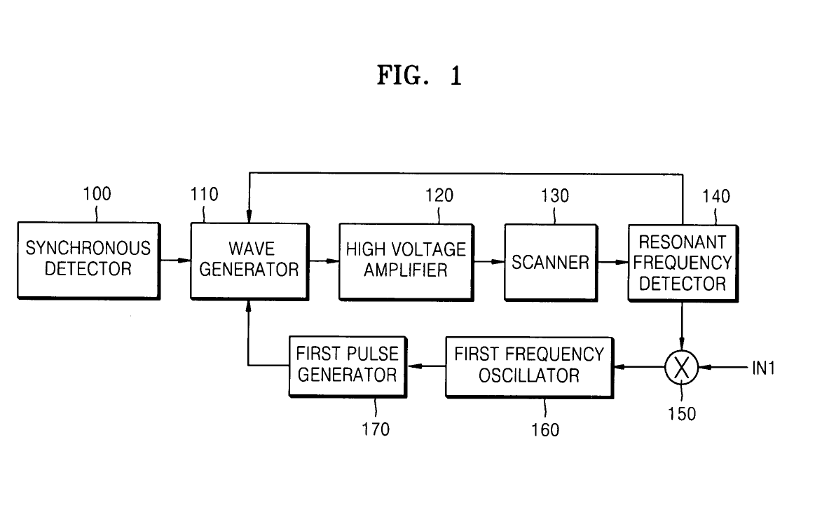

FIG. 1 is a block diagram of an image resolution enhancer according to an exemplary embodiment of the present invention. Referring to FIG. 1, the image resolution enhancer includes a synchronous detector 100, a wave generator 110, a high voltage amplifier 120, a scanner 130, a resonant frequency detector 140, a first multiplier 150, a first frequency oscillator 160, and a first pulse generator 170.

The synchronous detector 100 detects a horizontal synchronization signal of an image and outputs the detection result to the wave generator 110.

The wave generator 110 generates a triangle, square, or sine wave, adds a pulse received from the first pulse generator 170 to the triangle, square, or sine wave, and outputs to the high voltage amplifier 120 a composite waveform generated by adding the pulse to the triangle, square, or sine wave.

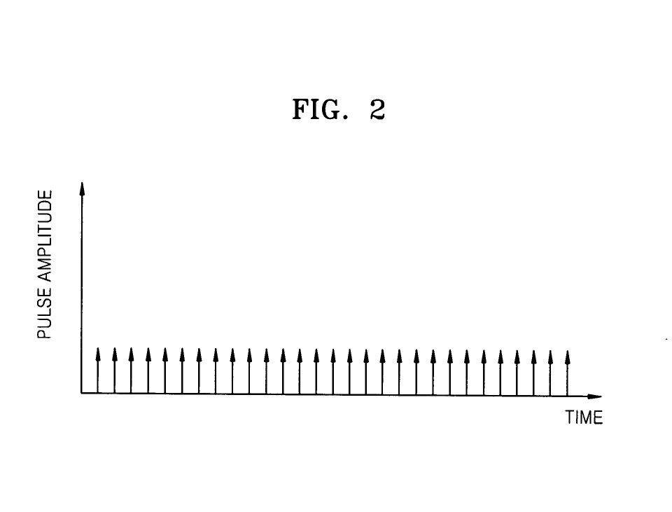

FIG. 2 shows a pulse generated by the pulse generator 170 according to an exemplary embodiment of the present invention. The period of the pulse is determined according to the frequency at which the first frequency oscillator 160 oscillates.

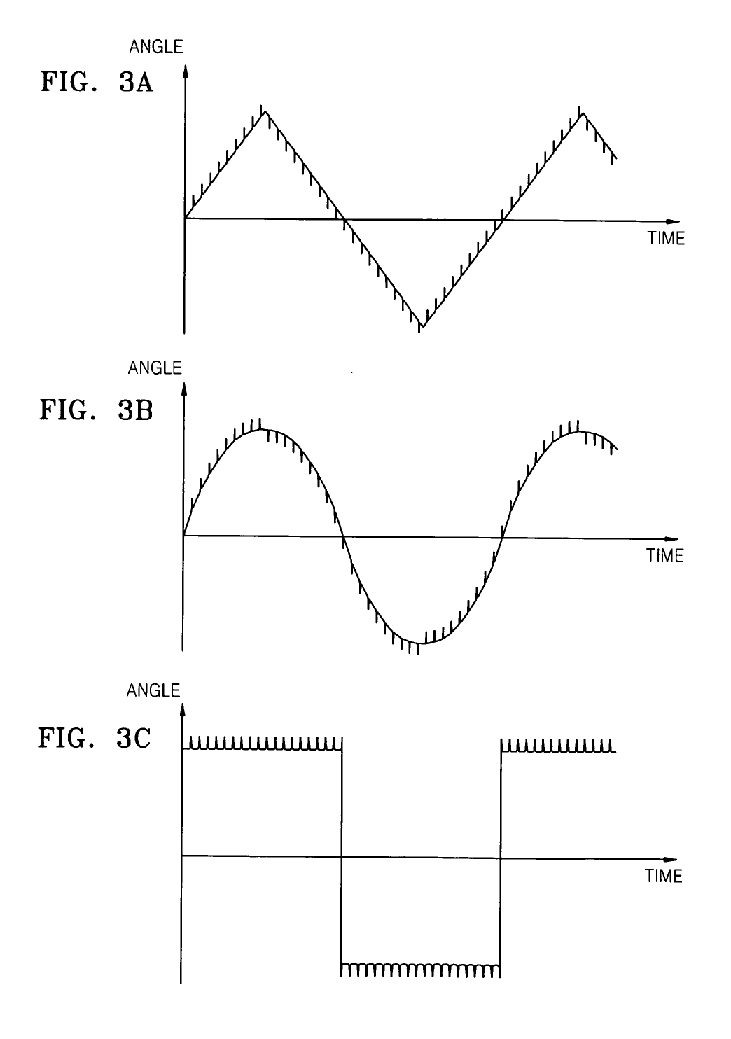

FIGS. 3A through 3C show various composite waveforms generated by adding a pulse to triangle, square, and sine waves according to exemplary embodiments of the present invention. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C. As shown in FIGS. 3A through 3C, the composite waveform generated by the wave generator 110 is different from an original wave. That is, while the original wave is the triangle, square, or sine wave which varies smoothly with time, the composite waveform according to an exemplary embodiment of the present invention has peaks due to the pulse which is added to the original wave. The image quality is improved due to the peaks when the scanner 130 scans the image.

The high voltage amplifier 120 amplifies the waveform generated by the wave generator 110 and outputs the amplification result to the scanner 130.

In particular, the high voltage amplifier 120 amplifies the composite waveform generated by the wave generator 110.

The scanner 130 scans the image to a display screen according to the waveform received by the high voltage amplifier 120.

When receiving the composite waveform shown in one of FIGS. 3A through 3C, the scanner 130 scans the image to the display screen according to the composite waveform. The scanner 130 scans the pixels of the image with reference to the peaks resulting from the added pulse, and therefore, the image is prevented from being scanned in areas between pixels. As a result, the quality of the image which is scanned according to the composite waveform is high relative to the quality of an image which is scanned in the related art.

The resonant frequency detector 140 detects the resonant frequency of the scanner 130 and outputs the detection result to the first multiplier 150.

The first multiplier 150 multiplies the resonant frequency of the scanner 130 detected by the resonant frequency detector 140 by the horizontal resolution of the display screen, which is input through an input terminal IN1, and outputs the multiplication result to the first frequency oscillator 160. The horizontal resolution of the display screen is the number of pixels in a row of the display screen.

For example, when the resonant frequency of the scanner is 25 KHz and the horizontal resolution of the display screen is 400 pixels, the first multiplier 150 multiplies the resonant frequency of 25 KHz by the horizontal resolution of 400 pixels and outputs the multiplication result of 10,000 KHz.

The first frequency oscillator 160 oscillates at a pixel frequency which corresponds to the multiplication result of the first multiplier 150 and outputs the oscillation result to the first pulse generator 170. For example, when receiving the multiplication result of 10,000 KHz from the multiplier 150, the first multiplier 150 oscillates at the pixel frequency which corresponds to the received multiplication result.

The first pulse generator 170 generates the pulse which corresponds to the pixel frequency oscillations of the first frequency oscillator 160 and outputs the generated pulse to the wave generator 110. For example, the first pulse generator 170 can generate the pulse shown in FIG. 2. The period of the pulse is determined according to the frequency at which the first frequency oscillator 160 oscillates.

The wave generator 110 generates and outputs the composite waveform by adding the pulse received from the first pulse generator 170 to the triangle, square, or sine wave. When outputting the composite waveform from the high voltage amplifier 120 to the scanner 130, the scanner 130 outputs the image to the display screen according to the composite waveform.

The image resolution enhancer shown in FIG. 1 can be included in a display device in which an electrostatic capacity micro mirror is used as a scanner.

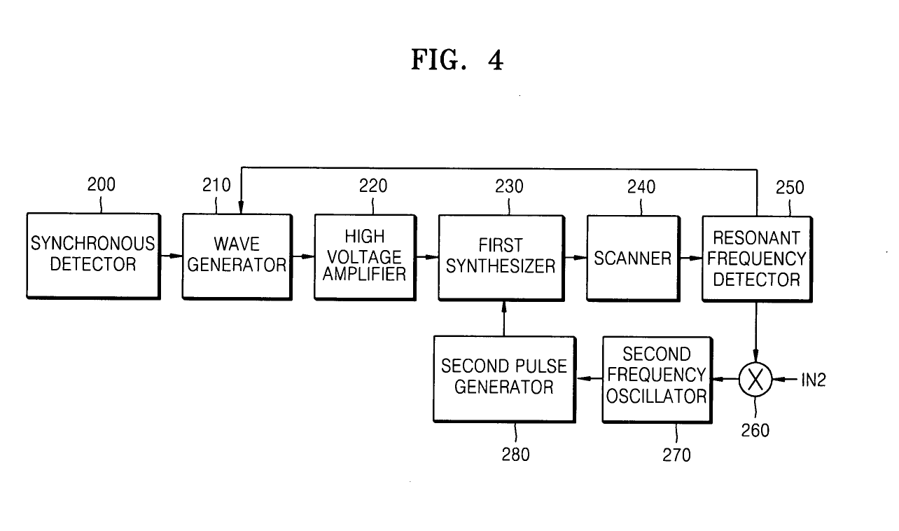

FIG. 4 is a block diagram of an image resolution enhancer according to another exemplary embodiment of the present invention. Referring to FIG. 4, the image resolution enhancer includes a synchronous detector 200, a wave generator 210, a high voltage amplifier 220, a first synthesizer 230, a scanner 240, a resonant frequency detector 250, a second multiplier 260, a second frequency oscillator 270, and a second pulse generator 280.

The synchronous detector 200 detects a horizontal synchronization signal of an image and outputs the detection result to the wave generator 210.

The wave generator 210 generates a triangle, square, or sine wave and outputs the generated wave to the high voltage amplifier 220.

The high voltage amplifier 220 amplifies the wave generated by the wave generator 210 and outputs the amplification result to the first synthesizer 230.

The first synthesizer 230 adds the pulse generated by the second pulse generator 280 to the wave amplified by the high voltage amplifier 220, and outputs the composite waveform to the scanner 240. In particular, the first synthesizer 230 outputs the composite waveform generated by adding the pulse to the triangle, square, or sine wave.

For example, the first synthesizer 230 can generate one of the composite waveforms shown in FIGS. 3A through 3C. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C. The composite waveform generated by the first synthesizer 230 has peaks resulting from the pulse which is added to the original wave. The peaks correspond to the pixels. The image quality is improved due to the peaks when the scanner 240 scans the image.

The scanner 240 scans the image to a display screen according to the composite waveform received from the first synthesizer 230. When receiving the composite waveform shown in one of FIGS. 3A through 3C, the scanner 240 scans the image to the display screen according to the composite waveform. The scanner 240 scans the pixels of the image with reference to the peaks resulting from the added pulse, and therefore, the image is prevented from being scanned in areas between the pixels. As a result, the quality of the image which is scanned according to the composite waveform is high relative to the quality of an image which is scanned in the related art.

The resonant frequency detector 250 detects a resonant frequency of the scanner 240 and outputs the detection result to the second multiplier 260.

The second multiplier 260 multiplies the resonant frequency of the scanner 240 detected by the resonant frequency detector 250 by the horizontal resolution of the display screen, which is input through an input terminal IN2, and outputs the multiplication result to the second frequency oscillator 270. The horizontal resolution of the display screen is the number of pixels in a row of the display screen.

The second frequency oscillator 270 oscillates at a pixel frequency which corresponds to the multiplication result of the second multiplier 260 and outputs the oscillation result to the second pulse generator 280. For example, when receiving the multiplication result of 10,000 KHz from the second multiplier 260, the second multiplier 260 oscillates at the pixel frequency corresponding to the received multiplication result.

The second pulse generator 280 generates the pulse having the pixel frequency in response to the oscillations of the second frequency oscillator 270 and outputs the generated pulse to the first synthesizer 230. For example, the second pulse generator 280 generates the pulse shown in FIG. 2.

When the first synthesizer 230 generates the wave by adding the pulse received from the second pulse generator 280 to the wave amplified by the high voltage amplifier 220 and outputs the composite waveform to the scanner 240, the scanner 240 outputs the image to the display screen according to the composite waveform.

The image resolution enhancer shown in FIG. 4 can be included in a display device in which an electrostatic capacity micro mirror is used as a scanner.

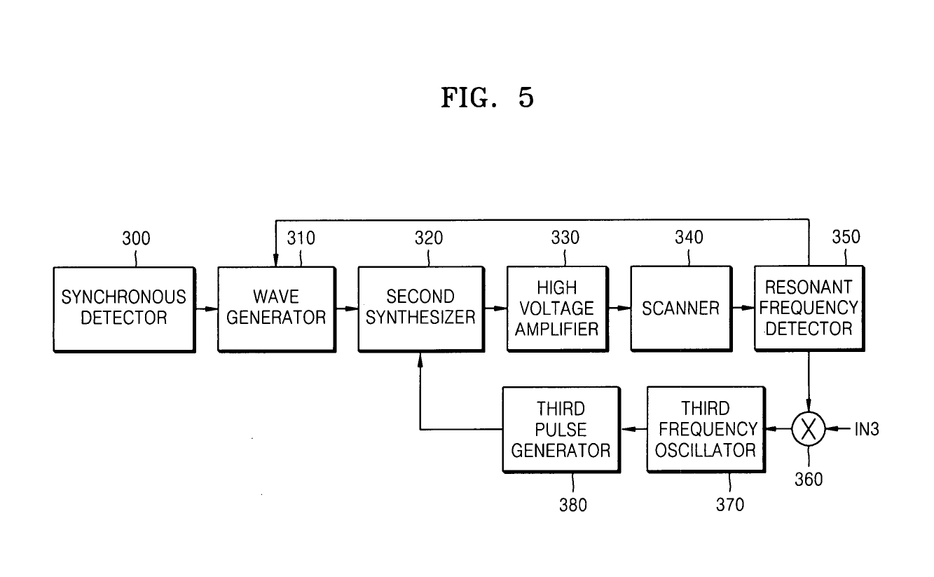

FIG. 5 is a block diagram of an image resolution enhancer according to another exemplary embodiment of the present invention. Referring to FIG. 5, the image resolution enhancer includes a synchronous detector 300, a wave generator 310, a second synthesizer 320, a high voltage amplifier 330, a scanner 340, a resonant frequency detector 350, a third multiplier 360, a third frequency oscillator 370, and a third pulse generator 380.

The synchronous detector 300 detects a horizontal synchronization signal of an image and outputs the detection result to the wave generator 310.

The wave generator 310 generates the triangle, square, or sine wave and outputs the generated wave to the second synthesizer 320.

The second synthesizer 320 adds a pulse generated by the third pulse generator 380 to the wave generated by the wave generator 310 and outputs the composite waveform to the high voltage amplifier 330. In particular, the second synthesizer 320 outputs the waveform generated by adding the pulse to the triangle, square, or sine wave.

For example, the second synthesizer 320 generates one of the composite waveforms shown in FIGS. 3A through 3C. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C. The composite waveform generated by the second synthesizer 320 has peaks due to the pulse which is added to the original wave. The peaks correspond to the pixels. The image quality is improved due to the peaks when the scanner 340 scans the image.

The high voltage amplifier 330 amplifies the composite waveform generated by the second synthesizer 320 and outputs the amplification result to the scanner 340.

The scanner 340 scans the image to a display screen according to the wave received from the high voltage amplifier 330. When receiving the composite waveform shown in one of FIGS. 3A through 3C, the scanner 340 scans the image to the display screen according to the composite waveform. The scanner 340 scans the pixels of the image with reference to the peaks resulting from the added pulse, and therefore, the image is prevented from being scanned in areas between pixels. As a result, the quality of the image which is scanned according to the composite waveform is high relative to the quality of an image which is scanned in the related art.

The resonant frequency detector 350 detects a resonant frequency from the scanner 340 and outputs the detection result to the third multiplier 360.

The third multiplier 360 multiplies the resonant frequency of the scanner 340, which is detected by the resonant frequency detector 350, by the horizontal resolution of the display screen, which is input through an input terminal IN3, and outputs the multiplication result to the third frequency oscillator 370. The horizontal resolution of the display screen is the number of pixels in a row of the display screen.

The third frequency oscillator 370 oscillates at a pixel frequency which corresponds to the multiplication result of the third multiplier 360 and outputs the oscillation result to the third pulse generator 380. For example, when receiving a multiplication result of 10,000 KHz from the third multiplier 360, the third multiplier 360 oscillates at the pixel frequency corresponding to the received multiplication result.

The third pulse generator 380 generates the pulse corresponding to the pixel frequency by the oscillations of the third frequency oscillator 370 and outputs the generated pulse to the second synthesizer 320. For example, the third pulse generator 380 can generate the pulse shown in FIG. 2.

When the second synthesizer 320 generates the waveform by adding the pulse received from the third pulse generator 380 to the wave amplified by the high voltage amplifier 330 and outputs the composite waveform to the scanner 340, the scanner 340 outputs the image to the display screen according to the composite waveform.

The image resolution enhancer shown in FIG. 5 can be included in a display device in which an electrostatic capacity micro mirror is used as a scanner.

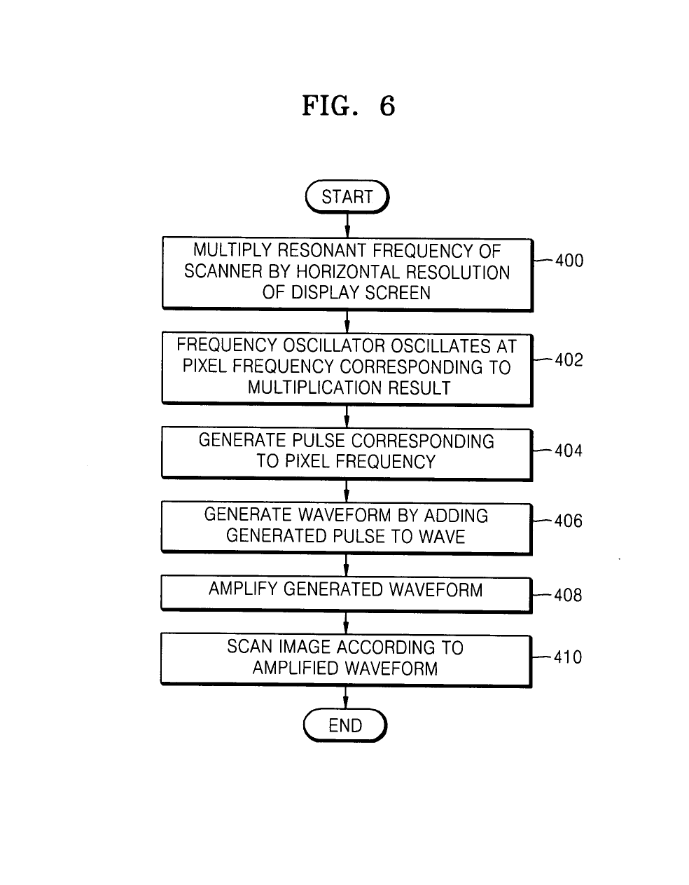

FIG. 6 is a flowchart of an image resolution enhancing method according to an exemplary embodiment of the present invention.

A resonant frequency detected by a resonant frequency detector is multiplied by a horizontal resolution of a display screen (operation 400). The horizontal resolution of the display screen is the number of pixels in a row of the display screen.

After operation 400, a frequency oscillator oscillates at a pixel frequency which corresponds to the multiplication result (operation 402). For example, when the multiplication result is 10,000 KHz, the frequency oscillator oscillates at the pixel frequency corresponding to the multiplication result, i.e., 10,000 KHz.

After operation 402, a pulse corresponding to the pixel frequency at which the frequency oscillator oscillates is generated and is output to a wave generator (operation 404). For example, the pulse shown in FIG. 2 can be generated. The period of the pulse is determined according to the frequency at which the frequency oscillator oscillates.

After operation 404, the wave generator generates a composite waveform by adding the pulse to a triangle, square, or sine wave, and outputs the composite waveform (operation 406). FIG. 3 shows various composite waveforms generated by adding pulses to triangle, square and sine waves according to exemplary embodiments of the present invention. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C.

After operation 406, a high voltage amplifier amplifies the composite waveform generated by the wave generator (operation 408).

After operation 408, a scanner scans the image to the display screen according to the amplified wave (operation 410). When receiving the composite waveform shown in one of FIGS. 3A through 3C, the scanner scans the pixels of the image with reference to the peaks resulting from the added pulse, and therefore the image is prevented from being scanned in areas between pixels. Therefore, the quality of the image which is scanned in accordance with a composite waveform is high relative to the quality of an image which is scanned in the related art.

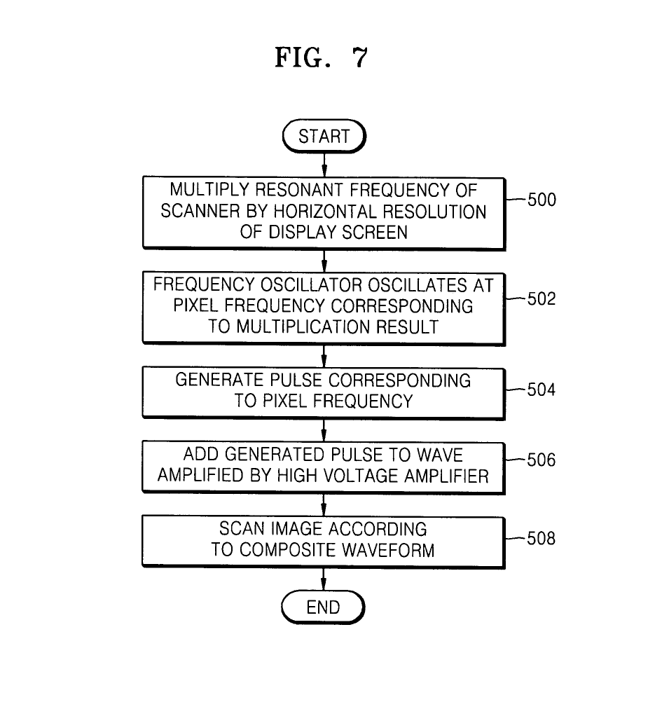

FIG. 7 is a flowchart of an image resolution enhancing method according to another exemplary embodiment of the present invention.

A resonant frequency detected by a resonant frequency detector is multiplied by the horizontal resolution of a display screen (operation 500). The horizontal resolution of the display screen is the number of pixels in a row of the display screen.

After operation 500, a frequency oscillator oscillates at a pixel frequency corresponding to the multiplication result (operation 502). For example, when the multiplication result is 10,000 KHz, the frequency oscillator oscillates at the pixel frequency corresponding to the multiplication result, i.e., 10,000 KHz.

After operation 502, a pulse corresponding to the pixel frequency at which the frequency oscillator oscillates is generated and output to a wave generator (operation 504). For example, the pulse shown in FIG. 2 can be generated. The period of the pulse is determined in accordance with the frequency at which the frequency oscillator oscillates.

After operation 504, the pulse generated in operation 504 is added to a triangle, square or sine wave which is generated by the wave generator and amplified by a high voltage amplifier, and the resultant composite waveform is output to a scanner (operation 506).

FIG. 3 shows various composite waveforms generated by adding pulses triangle, square and sine waves according to exemplary embodiments of the present invention. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C.

After operation 506, the scanner scans the image to the display screen according to the composite waveform (operation 508). When receiving the composite waveform shown in one of FIGS. 3A through 3C, the scanner scans the pixels of the image with reference to the peaks resulting from the added pulse, and therefore, the image is prevented from being scanned in areas between pixels. As a result, the quality of the image which is scanned in accordance with a composite waveform generated by adding the pulse is high relative to the quality of an image which is scanned in the related art.

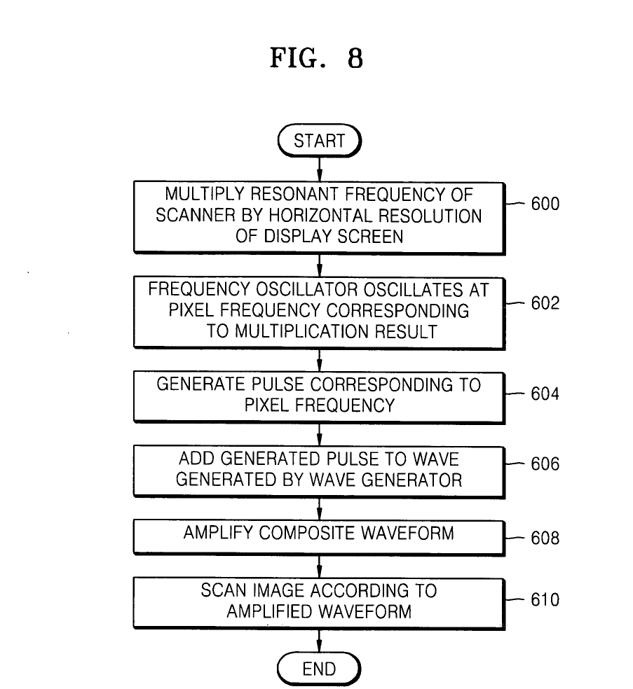

FIG. 8 is a flowchart of an image resolution enhancing method according to another exemplary embodiment of the present invention.

A resonant frequency detected by a resonant frequency detector is multiplied by the horizontal resolution of a display screen (operation 600). The horizontal resolution of the display screen is the number of pixels in a row of the display screen.

After operation 600, a frequency oscillator oscillates at a pixel frequency corresponding to the multiplication result (operation 602). For example, when the multiplication result is 10,000 KHz, the frequency oscillator oscillates at the pixel frequency corresponding to the multiplication result, i.e., 10,000 KHz.

After operation 602, a pulse corresponding to the pixel frequency is generated and output to a wave generator (operation 604). For example, the pulse shown in FIG. 2 can be generated. The period of the pulse is determined in accordance with the frequency at which the frequency oscillator oscillates.

After operation 604, the pulse generated in operation 604 is added to a triangle, square or sine wave which is generated by the wave generator to obtain a composite waveform (operation 606).

FIG. 3 shows various composite waveforms generated by adding pulses to triangle, square and sine wave according to exemplary embodiments of the present invention. A composite waveform generated by adding the pulse shown in FIG. 2 to the triangle wave is shown in FIG. 3A. A composite waveform generated by adding the pulse shown in FIG. 2 to the sine wave is shown in FIG. 3B. A composite waveform generated by adding the pulse shown in FIG. 2 to the square wave is shown in FIG. 3C.

After operation 606, the high voltage amplifier amplifies the composite waveform (operation 608).

After operation 608, the scanner scans the image to a display screen according to the amplified waveform (operation 610). When receiving the composite waveform shown in one of FIGS. 3A through 3C, the scanner scans the pixels of the image with reference to the peaks resulting from the added pulse, and therefore, the image is prevented from being scanned in areas between pixels. As a result, the quality of the image which is scanned in accordance with a composite waveform generated by adding the pulse is high relative to the quality of an image which is scanned in the related art.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion. Also, functional programs, code, and code segments for accomplishing exemplary embodiments of the present invention can be easily construed by programmers skilled in the art to which the exemplary embodiments of the present invention pertains.

While the image resolution enhancer and the image resolution enhancing method according to the present invention have been particularly shown and described with reference to exemplary embodiments thereof, it will be understood by those of ordinary skill in the art that various changes in form and details may be made therein without departing from the spirit and scope of the present invention as defined by the following claims.

The image resolution enhancer and the image resolution enhancing method according to the exemplary embodiments of the present invention can improve the horizontal resolution by driving the micro-mirror of the scanner in consideration of the pixel frequency.

What is claimed is:

1. An image resolution enhancing apparatus comprising:
a scanner;
a synchronous detector;
a wave generator;
a high voltage amplifier;
a resonant frequency detector which detects a resonant frequency of the scanner;
a multiplier which multiplies the detected resonant frequency by a horizontal resolution of a display screen;
a frequency oscillator which oscillates at a pixel frequency which corresponds to a multiplication result of the multiplier; and
a pulse generator which generates a pulse which corresponds to a pixel frequency at which the frequency oscillator oscillates, and provides the generated pulse to the wave generator,
wherein the wave generator adds the pulse generated by the pulse generator to a wave to generate a composite waveform.

2. The image resolution enhancing apparatus of claim 1, wherein the wave generator generates the composite waveform by adding the pulse to a triangle wave, a square wave, or a sine wave.

3. The image resolution enhancing apparatus of claim 1, wherein the image resolution enhancing apparatus is included in a display device which uses an electrostatic capacity micro mirror.

4. An image resolution enhancing apparatus comprising:
a scanner;
a synchronous detector;
a wave generator;
a high voltage amplifier;
a resonant frequency detector which detects a resonant frequency of the scanner;
a multiplier which multiplies the detected resonant frequency by a horizontal resolution of a display screen;
a frequency oscillator which oscillates at a pixel frequency which corresponds to a multiplication result of the multiplier;
a pulse generator which generates a pulse which corresponds to a pixel frequency at which the frequency oscillator oscillates; and
a synthesizer which adds the pulse which is generated by the pulse generator to a wave which is generated by the wave generator and amplified by the high voltage amplifier and outputs the composite waveform to the scanner.

5. The image resolution enhancing apparatus of claim 4, wherein the synthesizer outputs the composite waveform generated by adding the pulse to a triangle wave, a square wave, or a sine wave, and the wave generator generates the triangle, the square wave, or the sine wave.

6. The image resolution enhancing apparatus of claim 4, wherein the image resolution enhancing apparatus is included in a display device using an electrostatic capacity micro mirror.

7. An image resolution enhancing apparatus comprising:
a scanner;
a synchronous detector;
a wave generator;
a high voltage amplifier;
a resonant frequency detector which detects a resonant frequency of the scanner;
a multiplier which multiplies the detected resonant frequency by a horizontal resolution of a display screen;
a frequency oscillator which oscillates at a pixel frequency which corresponds to a multiplication result of the multiplier;
a pulse generator which generates a pulse which corresponds to a pixel frequency at which the frequency oscillator oscillates; and
a synthesizer which adds the pulse generated by the pulse generator to a wave generated by the wave generator and outputs the generated composite wave to the high voltage amplifier.

8. The image resolution enhancing apparatus of claim 7, wherein the synthesizer outputs a composite waveform generated by adding the pulse to a triangle wave, a square wave, or a sine wave, and the wave generator generates the triangle wave, the square wave, or the sine wave.

9. The image resolution enhancing apparatus of claim 7, wherein the image resolution enhancing apparatus is included in a display device using an electrostatic capacity micro mirror.

10. An image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency and providing the pulse to the wave generator;
generating a waveform in the wave generator by adding the pulse to a wave;
amplifying the waveform in the high voltage amplifier; and
scanning an image in the scanner according to the amplified waveform.

11. The method of claim 10, wherein the generating the waveform comprises generating a composite waveform by adding the pulse to a triangle wave, a square wave, or a sine wave.

12. The method of claim 10 being performed in a display device using an electrostatic capacity micro mirror.

13. A computer-readable recoding medium having embodied thereon a computer program for performing an image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency and providing the pulse to the wave generator;
generating a waveform in the wave generator by adding the pulse to a wave;
amplifying the waveform in the high voltage amplifier; and
scanning an image in the scanner according to the amplified waveform.

14. An image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency;
adding the generated pulse to a wave which is generated by the wave generator and amplified by the high voltage amplifier to obtain a composite waveform and providing the composite waveform to the scanner; and
scanning an image in the scanner according to the composite waveform.

15. The method of claim 14, wherein the generating the pulse comprises outputting a composite waveform generated by adding the pulse to a triangle wave, a square wave, or a sine wave.

16. The method of claim 14 being performed in a display device using an electrostatic capacity micro mirror.

17. A computer-readable recoding medium having embodied thereon a computer program for performing an image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency;
adding the generated pulse to a wave which is generated by the wave generator and amplified by the high voltage amplifier to obtain a composite waveform and providing the composite waveform to the scanner; and
scanning an image in the scanner according to the composite waveform.

18. An image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency
adding the generated pulse to a wave which is generated by the wave generator to obtain a composite waveform and outputting the composite waveform to the high voltage amplifier;
amplifying the composite waveform in the high voltage amplifier; and
scanning an image in the scanner according to the amplified waveform.

19. The method of claim 18, wherein the adding the generated pulse to the wave comprises outputting a composite waveform generated by adding the pulse to a triangle wave, a square wave, or a sine wave.

20. The method of claim 18 being performed in a display device using an electrostatic capacity micro mirror.

21. A computer-readable recoding medium having embodied thereon a computer program for performing an image resolution enhancing method performed in an image resolution enhancing apparatus comprising a scanner, a synchronous detector, a wave generator, a high voltage amplifier, and a resonant frequency detector, the method comprising:
detecting a resonant frequency of the scanner using the resonant frequency detector;
multiplying the detected resonant frequency by a horizontal resolution of a display screen;
oscillating at a pixel frequency corresponding to a result of the multiplying;
generating a pulse corresponding to the pixel frequency;
adding the generated pulse to a wave which is generated by the wave generator to obtain a composite waveform and outputting the composite waveform to the high voltage amplifier;
amplifying the composite waveform in the high voltage amplifier; and
scanning an image in the scanner according to the amplified waveform.
